(19) United States
(12) Patent Application Publication
(10) Pub. No.: US 2009/0171858 A1
(43) Pub. Date: Jul. 2, 2009

(54) Method and system for the exchange of intellectual property assets

(76) Inventor: Benjamin J. Kwitek, Canon City, CO (US)

Correspondence Address: WELSH & FLAXMAN LLC, 2000 DUKE STREET, SUITE 100, ALEXANDRIA, VA, 22314, US

(21) Appl. No.: 12/318,553

(22) Filed: Dec. 31, 2008

Related U.S. Application Data
(60) Provisional application No. 61/006,212, filed on Dec. 31, 2007.

(51) Int. Cl. G06Q 40/00; G06Q 50/00

(52) U.S. Cl. 705/36 R; 705/37

(57) ABSTRACT

A computer based method and system for exchange of intellectual property assets which permits intellectual property IP) buyers and IP sellers to interact via a marketplace exchange includes a marketplace exchange accessed via a global communication network by IP buyers and IP sellers through utilization of computers. The marketplace exchange also includes a mechanism for posting of a listing of IP sellers on the marketplace exchange and a transactions section for facilitating transactions relating to intellectual property assets posted on the marketplace exchange.

### CROSS REFERENCE TO RELATED APPLICATIONS

This application claims the benefit of U.S. Provisional Patent Application Ser. No. 61/006,212, filed Dec. 31, 2007, entitled “METHOD AND SYSTEM FOR THE EXCHANGE OF INTELLECTUAL PROPERTY ASSETS”.

### BACKGROUND OF THE INVENTION

1. Field of the Invention

The invention relates to the marketing, research, and sale of intellectual property assets. More specifically, the invention relates to the creation of an online or Internet-based marketplace exchange for the listing, communication, review and sale of patents, trademarks, copyrights and other intellectual property assets.

2. Description of the Related Art

The modern economy has produced unprecedented economic growth and development across the world. In developed nations, including the U.S., Western Europe and Japan, this surge has been rooted in intellectual property. One cannot imagine life without computers, pharmaceutical drugs or popular consumer brands, and most of these products are protected in some way by intellectual property rights in the form of patents, trademarks and copyrights.

Almost any modern product or service is protected by various intellectual property assets. With as much of the world's manufacturing and services moving to lower cost nations, intellectual property is an important asset of many contemporary companies in ensuring their proprietary interest in the product. Without their trademarks across the planet, Coca-Cola would simply be a company that makes carbonated sugar water. IBM would not have a leadership role, and certainly would not earn a billion dollars a year on licensing, without its intellectual property portfolio.

The Internet and advanced technology allows people anywhere in the world to witness the best products from other nations throughout the world. Today's online marketplace includes products of all sorts. Intellectual property assets have, however, not been a part of this market evolution.

Across the globe there ate many specific problems to the development of intellectual property assets. The U.S. system for protecting and growing intellectual property assets is unique. The Founding Fathers implemented a system that benefited and protected the individual and his or her ideas. Since the late 18^{th} century, the U.S. Patent and Trademark Office has issued over seven million patents and millions of trademarks. When combined with the millions of copyrights, one can clearly see the enormity of intellectual property assets held within the U.S. The key problem with intellectual property is the marketplace. Like any complicated marketplace, there are literally millions of potential buyers and sellers.

There are three key components to the intellectual property marketplace that make it problematic. One, there is the inventor. Many of the intellectual property assets in the U.S. and beyond are held by individuals, colleges and small companies. Most inventors are part-time innovators and have other jobs and responsibilities that often times come before the development of their intellectual property. Often times the inventor does not want to create a company to further pursue his or her ideas. They might want to sell or license their idea to another person or company. This is part of the American Dream. Unfortunately, most inventors do not have the resources (primarily money) to develop their ideas beyond the patent application, or granting of the patent. These patents are then simply forgotten, usurped or mothballed. Ultimately, when faced with developing his or her idea, including design, manufacturing, marketing and distribution, most small inventors are ill equipped for the challenge.

The stories of individual inventors presenting their ideas to large companies is almost archetypal in the American folklore. Often times these companies turn away the inventor early in the process without even seriously considering the potential for the intellectual property assets presented for their review.

There is also the problem of theft. Unfortunately, people within large and small companies sometimes listen to the ideas of the small inventor and then turn them away telling them the company is not interested. Months or years later, this same company might introduce the same product or innovation. The inventor loses the idea and the profit he or she expected. They are left with the expensive and timely dilemma of litigation.

Two, there is the company or potential buyer. A majority of large companies are not interested in dealing with countless inventors and “crazy” entrepreneurs with ideas. Even though these ideas might improve their products or launch new businesses, large companies simply do not have the human resources or procedural processes to manage this inflow of ideas.

The challenge, however, is that modern companies need innovation to grow their businesses and compete in a global market. As such, there is a real imperative for innovation and new technology. Although companies typically spend a lot of money on internal research and development (R&D), they cannot hope to develop every idea first from within their cloistered walls. The market is simply too quick and diverse. As a result, how can companies access the best ideas in an efficient and corporate-friendly manner?

Three, there is the efficiency problem which supersedes both the issues of the seller and buyer. Imagine the difficulty involved with a potential exchange. The responsibility generally rests with the seller. He or she must identify target buyers for their idea. After finding them, the seller needs to contact them. If he or she is fortunate enough to find the right person or persons, they must then execute a confidentiality agreement. The inventor is then faced with presenting the idea to the company and hoping it gets reviewed by a company employee capable of appreciating the benefits offered by the idea. Alternatively, the inventor may choose to meet with the buyer's agents in person. If there is any interest, the negotiations may take months or years. This is highly impractical for all parties. This entire introduction process is lengthy and expensive.

The process of transferring intellectual property assets is too cumbersome and often resembles an awkward social courtship. As a result, a need exists for a system and methodology enhancing the transfer of intellectual property assets within the marketplace. The present invention provides such a system.

### SUMMARY OF THE INVENTION

It is, therefore, an object of the present invention to provide a computer based system for exchange of intellectual property assets which permits intellectual property (IP) buyers and IP sellers to interact via a marketplace exchange. The system includes a marketplace exchange accessed via a global communication network by IP buyers and IP sellers through utilization of computers. The marketplace exchange also includes means for posting a listing of IP sellers on the marketplace exchange and a transactions section for facilitating transactions relating to intellectual property assets posted on the marketplace exchange.

It is also an object of the present invention to provide a system wherein the marketplace exchange is a computer-based database of information functioning as a centralized collection point for those wishing to buy, sell and research intellectual property assets.

It is another object of the present invention to provide a system wherein the means for posting the listing of IP sellers includes posting intellectual property assets on the marketplace exchange.

It is a further object of the present invention to provide a system wherein the posting includes reference information and some summary information of the intellectual property assets on the marketplace exchange.

It is also an object of the present invention to provide a system including means for screening and analyzing intellectual property assets presented on the marketplace exchange.

It is another object of the present invention to provide a system wherein the means for screening and analyzing includes providing ratings.

It is a further object of the present invention to provide a system wherein the means for screening and analyzing includes a software program analyzing key words and data from third-party sources.

It is also an object of the present invention to provide a system wherein the transactions section includes the provision of a purchase option.

It is another object of the present invention to provide a system further including a feedback and data sharing section storing information obtained from prospective IP buyers.

It is a further object of the present invention to provide a system further including means for providing automated updates of intellectual property assets and information.

It is also an object of the present invention to provide a method for exchange of intellectual property assets which permits intellectual property (IP) buyers and IP sellers to interact via a marketplace exchange comprising providing a marketplace exchange accessed via a global communication network by the IP buyers and IP sellers through utilization of computers, posting a listing of IP sellers on the marketplace exchange, facilitating transactions relating to the intellectual property assets.

It is another object of the present invention to provide a method wherein the marketplace exchange is a computer-based database of information functioning as a centralized collection point for those wishing to buy, sell and research intellectual property assets.

It is a further object of the present invention to provide a method wherein the step of posting includes posting intellectual property assets on the marketplace exchange.

It is also an object of the present invention to provide a method wherein the posting includes reference information and some summary information of the intellectual property assets on the marketplace exchange.

It is a further object of the present invention to provide a method further including the step of screening and analyzing intellectual property assets presented on the marketplace exchange.

It is another object of the present invention to provide a method wherein the step of screening and analyzing includes providing ratings.

It is also an object of the present invention to provide a method wherein the step of screening and analyzing includes employing a software program analyzing key words and data from third-party sources.

It is another object of the present invention to provide a method wherein the step of facilitating transactions includes the provision of a purchase option.

It is a further object of the present invention to provide a method further including the step of providing a feedback and data sharing section storing information obtained from prospective IP buyers.

It is also an object of the present invention to provide a method further including the step of providing automated updates of intellectual property assets and information.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the present system for the exchange of intellectual property assets.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

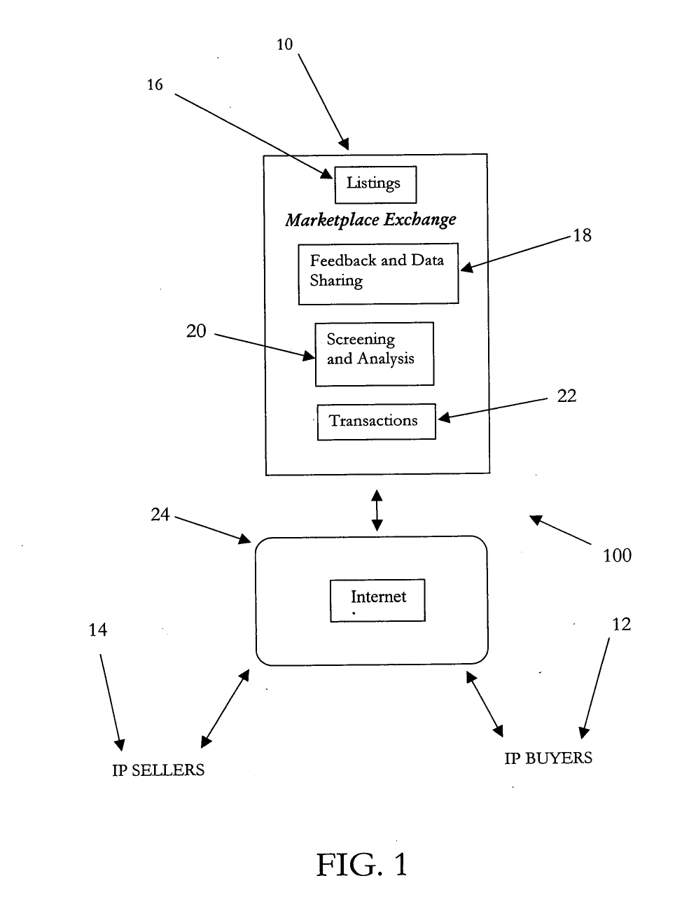

In accordance with the present invention, and with reference to FIG. 1, there are three major components to the present online, or Internet-based, computer based method and system 100 for the exchange of intellectual property assets which permits intellectual property (IP) buyers 12 and IP sellers 14 to interact via a marketplace exchange 10. In accordance with a preferred embodiment, the marketplace exchange 10 takes the form of a computer-based database of raw and processed information accessed via a global communication network (for example, the Internet) 24 by the IP buyers 12 and IP sellers 14 through the utilization of computers. As those skilled in the art will certainly appreciate, the term “intellectual property assets” as used throughout the present disclosure is intended to refer to patents, trademarks, copyrights, trade secrets, trade dress, other intellectual property rights recognized by governmental agencies, and applications therefore.

First, the present invention provides for the creation of a virtual or Internet and computer based marketplace exchange 10. Second, the present invention provides a mechanism for posting of a listing(s) 16 of the intellectual property asset(s) of inventors and owners (that is IP sellers 14) on the marketplace exchange 10. Third, the present invention provides a process for IP buyer 12 registration, review through a feedback and data sharing section 18, a screening and analysis section 20, and a transactions section 22 for the purchase of (or other transactions relating to) intellectual property assets posted on the marketplace exchange 10.

With this in mind, the present method for the exchange of intellectual property assets which permits IP buyers and IP sellers to interact via a marketplace exchange includes providing a marketplace exchange 10 in the form of a computer-based database of raw and processed information accessed via a global communication network 24 by the IP buyers and IP sellers through the utilization of computers, posting of a listing(s) of the intellectual property asset(s) of IP sellers on the marketplace exchange and facilitating transactions relating to the intellectual property assets.

More particularly, and with reference to the marketplace exchange 10, the marketplace exchange 10 is a computer-based database functioning as a centralized collection point for those wishing to buy, sell and -research intellectual property assets. The marketplace exchange 10 lists, manages and sells various intellectual property assets for individuals, organizations and companies around the world.

These intellectual property assets are sold via the marketplace exchange 10, which, in accordance with a preferred embodiment of the present invention, is accessed in a manner similar to a traditional web site. It is contemplated the web site would utilize one or more popular domain addresses. The web site preferably has several pages, including pages for the IP buyers 12 and IP sellers 14 of the intellectual property assets. These pages link to the information available on the marketplace exchange 10 which contains the information relevant to the IP buyer 12 or IP seller 14. The operators of the present system 100 would earn money on the listing and sale of the intellectual property assets via the marketplace exchange 10. It is further contemplated subscription services could be offered to potential IP buyers 12. These services would provide various benefits to the subscribers.

As briefly mentioned above, the present invention provides for posting of a listing(s) 16 of the intellectual property asset(s) of inventors and owners (that is, IP sellers) on the virtual online marketplace exchange 10. Individual inventors, organizations and various companies preferably post their intellectual property assets that they wish to sell on the online marketplace exchange 10 via computer exchange with the computer-based database of the marketplace exchange 10. The owner (that is, the IP seller 14), or other person responsible for handling transactions relating to the intellectual property asset, is responsible for posting the number(s) (that is, the identifying registration, patent, application or other information identifying the intellectual property asset to be sold) and some summary information on the site (that is, the database of marketplace exchange 10) for listing and review in accordance with the present invention. After entering the information on the input screens, the data is transmitted to the managing company for the online marketplace exchange 10 of the present invention. This data is then incorporated into the online database of the marketplace exchange 10 so that other users may see and use the information.

In accordance with a preferred embodiment of the present invention, the company managing the online marketplace exchange 10 screens and analyzes the intellectual property assets that are presented on the marketplace exchange 10 via a screening and analysis section 20. Moreover, the intellectual property assets are evaluated and grouped so as to be more useful to potential IP buyers 12. The evaluation and ratings are based on objective and, perhaps, subjective measures. Evaluations, that is, implementation of the screening and analysis section 20, preferably occur through the use of software programs developed to analyze key words and data from third-party sources. The use of experts, including those within the various fields (such as a professor of computer science) might also be employed to help grade the submitted intellectual property assets.

Each piece of intellectual property listed on the online marketplace exchange 10 offers a purchase option via the transactions section 22 of the marketplace exchange 10. This could be a set price or it might involve an auction system. This will depend on the preferences of the IP seller 14 and IP buyer 12.

The present invention also discloses a process for IP buyer 12 registration, review and purchase of intellectual property assets posted on the online marketplace exchange 10. As one might imagine, companies are generally interested in finding new ideas that assist their businesses. The present invention and online marketplace exchange 10 facilitates this process.

Before purchasing intellectual property assets, the prospective IP buyers 12 are surveyed regarding their business and potential interests for utilization in the feedback and data sharing section 18 of the marketplace exchange 10. This information is stored within a profile at the site (that is, the marketplace exchange 10). This profile preferably has two components. The full profile is stored in a proprietary database that only the managers of the marketplace exchange 10 may access, as this full profile would likely contain confidential information. Thus, the full profile is edited and summarized for incorporation into the marketplace exchange 10 profile online. The full and confidential profile is then compared to the existing IP seller 14 information and intellectual property assets. This preferably happens through automated search and organization programs developed for this process. In accordance with a preferred embodiment, it is contemplated these programs would use mathematical equations (such as algorithms) to link various pieces of data to one another. This process could also be adaptive in that new inputs or new data might alter the comparison process. Moreover, the results themselves might then become part of the record and, along with user input, become referenced in future searches. In this way, the present process would develop a virtual intelligence in its organization and matching capabilities. It may also utilize match-making done by project or field managers at the online exchange company. As a result, IP buyers 12 could be offered the chance to view relevant intellectual property assets upon their registration.

The present system 100 also allows for automated updates with relevant intellectual property assets and even informational updates. This may include articles, statistics and general market trends. All of this data related to the intellectual property assets is summarized and presented to the users in various forms. These might include priority lists, charts, tables and graphical representations of the data. Common programs such as Adobe Acrobat, Microsoft Excel and Microsoft PowerPoint could be used to present, manage and save the data. These preferably include pictorial views of the intellectual property landscape - a visual way to show missing pieces within an intellectual property portfolio for example. The software programs and coding manage the database of the marketplace exchange 10 and provide the users option as to how they might want to be updated. Users are preferably given a profile and password to access updates within their section or profile. The updates, or even the availability of an update online, could also be sent via email to the users. The user are surveyed as to their preferences for the type, quantity and methods that they would prefer for their updates.

The present system 100 also provides virtual intelligence through the use of advanced environmental scanning and pattern recognition within the intellectual property space and beyond. It is anticipated the highlighted technologies and intellectual property assets could be connected to general trends and societal progress. This environmental scanning and pattern recognition might employ electronic searches empowered by software programs designed to find relationships.

In summary, the present invention provides a solution to the current problem of underdeveloped or underutilized intellectual property assets throughout the world. The present invention allows a natural and dynamic marketplace to develop. The owners of unused or underutilized intellectual property assets will become IP sellers in this online system. The individuals and companies in the market will become IP buyers of intellectual property assets in this online system. When combined with advanced search, listing and intelligence features, this system and invention provides clear benefits to our modern economy.

While the preferred embodiments have been shown and described, it will be understood that there is no intent to limit the invention by such disclosure, but rather, is intended to cover all modifications and alternate constructions falling within the spirit and scope of the invention.

1. A computer based system for exchange of intellectual property assets which permits intellectual property (IP) buyers and IP sellers to interact via a marketplace exchange, comprising:
a marketplace exchange accessed via a global communication network by IP buyers and IP sellers through utilization of computers;
the marketplace exchange includes means for posting of a listing of the IP sellers on the marketplace exchange and a transactions section for facilitating transactions relating to intellectual property assets posted on the marketplace exchange.

2. The system according to claim 1, wherein the marketplace exchange is a computer-based database of information functioning as a centralized collection point for those wishing to buy, sell and research intellectual property assets.

3. The system according to claim 1, wherein the means for posting of the listing of the IP sellers includes posting intellectual property assets on the marketplace exchange.

4. The system according to claim 3, wherein the posting includes reference information and some summary information of the intellectual property assets on the marketplace exchange.

5. The system according to claim 1, further including means for screening and analyzing intellectual property assets presented on the marketplace exchange.

6. The system according to claim 5, wherein the means for screening and analyzing includes providing ratings.

7. The system according to claim 6, wherein the means for screening and analyzing includes a software program analyzing key words and data from third-party sources.

8. The system according to claim 1, wherein the transactions section includes the provision of a purchase option.

9. The system according to claim 1, further including a feedback and data sharing section storing information obtained from prospective IP buyers.

10. The system according to claim 1, further including means for providing automated updates of intellectual property assets and information.

11. A method for exchange of intellectual property assets which permits intellectual property (IP) buyers and IP sellers to interact via a marketplace exchange, comprising:
providing a marketplace exchange accessed via a global communication network by the IP buyers and the IP sellers through utilization of computers;
posting a listing of the IP sellers on the marketplace exchange;
facilitating transactions relating to the intellectual property assets.

12. The method according to claim 11, wherein the marketplace exchange is a computer-based database of information functioning as a centralized collection point for those wishing to buy, sell and research intellectual property assets.

13. The method according to claim 11, wherein the step of posting includes posting intellectual property assets on the marketplace exchange.

14. The method according to claim 13, wherein the posting includes reference information and some summary information of the intellectual property assets on the marketplace exchange.

15. The method according to claim 11, further including the step of screening and analyzing intellectual property assets presented on the marketplace exchange.

16. The method according to claim 15, wherein the step of screening and analyzing includes providing ratings.

17. The method according to claim 16, wherein the step of screening and analyzing includes employing a software program analyzing key words and data from third-party sources.

18. The method according to claim 11, wherein the step of facilitating transactions includes the provision of a purchase option.

19. The method according to claim 11, further including the step of providing a feedback and data sharing section storing information obtained from prospective IP buyers.

20. The method according to claim 11, further including the step of providing automated updates of intellectual property assets and information.
